(19) United States
(12) Patent Application Publication
(10) Pub. No.: US 2026/0230482 A1
(43) Pub. Date: Aug. 6, 2026

(54) METHOD AND SYSTEM FOR OPERATING AN INTERNET OF THINGS (IOT) DEVICE

(71) Applicant: GIESECKE+DEVRIENT MOBILE SECURITY GERMANY GMBH, Munchen (DE)

(72) Inventors: Fernando SCHNEEBERGER, Munchen (DE); Dieter WEISS, Munchen (DE)

(21) Appl. No.: 19/146,045

(22) PCT Filed: Jan. 4, 2024
(86) PCT No.: PCT/DE2024/100002

§ 371 Date: Jul. 7, 2025

(30) Foreign Application Priority Data
Jan. 10, 2023 (DE) 10 2023 100 444.1

(51) Int. Cl. H04L 9/40

(52) U.S. Cl. CPC H04L 63/1416

(57) ABSTRACT

A method for operating an Internet of Things (IoT) device in which one step of the method, data is received from at least one IoT device by an operator platform. In a further step, the received data are evaluated by the operator platform, wherein the evaluation of the received data comprises at least determining whether the received data comprises an indication of a malfunction of the IoT device or unauthorized accessing of the IoT device. In a further step, state data of the IoT device are generated based on the evaluation, wherein the state data are representative of a current or impending state of the IoT device. In a further step, the IoT device is controlled based on the generated state data of the IoT device. A system is provided for operating an Internet of Things (IoT) device.

### FIELD OF THE INVENTION

The present invention relates to aspects of the security-related monitoring and management of Internet of Things (IoT) devices. The invention relates in particular to a method and a system for operating an Internet of Things (IoT) device.

### BACKGROUND OF THE INVENTION

The term “Internet of Things” (“IoT”) is generally understood to mean a network of physical objects that have sensors, software and communication capabilities in order to enable these objects to be networked with other systems. The objects themselves may in this case be referred to as so-called Internet of Things (IoT) devices. Data and information transfer is an essential part of the networking of IoT devices with other systems or devices. Since the IoT devices are sometimes also used to receive sensitive information, the IoT devices are regularly the target of unauthorized access with a view to procuring such information, for example in the context of what are referred to as hacker attacks. In addition, IoT devices may be prone to faults, which may potentially impair or even prevent frictionless data and information transfer.

### Description

One object of the present invention is to improve the management of IoT devices.

This object is achieved by the subject matter of the independent claims. Exemplary embodiments will become apparent from the dependent claims and the following description.

According to one aspect, what is specified is a method for operating an Internet of Things (IoT) device. In one step of the method, data are received from at least one IoT device by an operator platform. In a further step of the method, the received data are evaluated by the operator platform, wherein the evaluation of the received data comprises at least determining whether the received data comprise an indication of a malfunction of the IoT device or unauthorized accessing of the IoT device. In a further step of the method, state data of the IoT device are generated based on the evaluation, wherein the state data are representative of a current or impending state of the IoT device. In a further step of the method, the IoT device is controlled based on the generated state data of the IoT device.

The method according to the invention, on the one hand, allows the operator platform to detect attacks on IoT devices and malfunctions in IoT devices at an early stage and, on the other hand, makes it possible to prevent such attacks and malfunctions at an early stage through appropriate control measures before any damage is able to occur. The method according to the invention in particular allows improved monitoring and management of IoT devices, wherein specific functions of the IoT devices are able to be controlled by the operator platform using the collected data.

It is possible for the operator platform to use machine learning techniques to improve the monitoring and management of the IoT device. It is possible here to use artificial neural networks to analyze the IoT device based on collected data and thus to monitor its state. This may comprise for example learning behaviors and typical functions of the IoT device that occur during operation of the IoT device. This may likewise also comprise learning indications of malfunctions of the IoT device or potential hacker attacks on the IoT device.

The operator platform, which may also be embodied here as a security platform, carries out the abovementioned method steps in order to monitor a behavior and/or functioning of the at least one IoT device. The operator platform is able to communicate with the at least one IoT device over a wireless or wired communication link. The operator platform may in particular receive data from the at least one IoT device and then collect them for example in a memory of the operator platform. In one example, the operator platform receives and/or collects data from a multiplicity of IoT devices. In this case, the operator platform may thus take on a central collection function and a central monitoring function for all of the multiplicity of IoT devices.

The at least one IoT device may be a technical appliance that records data within an environment around the appliance, for example using sensors, and then transmits these recorded data to the operator platform. The environment in which the IoT device is used may be an industrial environment, a commercial environment or a household environment. By way of example, the IoT device may be an industrial manufacturing installation that runs through various control processes during the manufacture of a product and records data during the manufacture of this product. Likewise, the IoT device may be a household appliance that runs through various application steps and in the process again records data.

The received data from the IoT device may comprise process-related data, such as for example current operating parameters of the IoT device. The received data may also comprise security-related data, such as for example data generated on the IoT device when the IoT device is accessed externally. Such access may for example be unpermitted or unauthorized accessing of the IoT device by a third party. This access may then generate specific data on the IoT device, said data then being received by the operator platform. In addition, the received data may contain information indicating unpermitted or unauthorized accessing of data of the IoT device, even though the accessing of data of the IoT device and the associated unpermitted or unauthorized acquisition thereof have not yet taken place. In this respect, the method according to the invention is also suitable for preventing or at least counteracting potentially impending unpermitted or unauthorized accessing of the IoT device through appropriate control measures.

Furthermore, the received data from the IoT device may comprise function-related data, which for example describe current functional properties of the IoT device. By way of example, the received data from the IoT device may contain an indication that the IoT device is not working or is not working correctly, that is to say if the IoT device is malfunctioning. In addition, the data may also contain information indicating a malfunction of the IoT device, even though the malfunction itself has not yet even occurred. In this respect, the method according to the invention is also suitable for preventing or at least counteracting potentially impending malfunctioning of the IoT device, including failure of the IoT device, through appropriate control measures.

Controlling or carrying out said control measures may comprise activating or deactivating certain functions of the IoT device. Provision may furthermore be made for the IoT device to be disconnected from the operator platform, a network or from another IoT device. In other words, the method according to the invention makes provision to actively control the IoT device based on the evaluation of the received data, in order thus, if necessary, to subsequently initiate countermeasures concerning for example fending off the unpermitted or unauthorized accessing of the IoT device or restoring correct functioning of the IoT device.

Based on the evaluation step, the operator platform thus generates state data representative of a current or impending state of the IoT device. The current state may be characterized for example by a malfunction of the IoT device present at the current time or current unauthorized accessing of the IoT device. The impending state may for example be characterized by a state that deviates from the normal state of the IoT device and itself does yet not constitute a malfunction or unauthorized access, but already indicates that a malfunction or unauthorized access is imminent. Such information about the states of the IoT device may be used as a basis for generating the state data that then serve as the basis for the control.

According to one embodiment, the evaluation of the received data comprises determining whether the received data comprise an indication of a malfunction of the IoT device that has already occurred or unauthorized accessing of the IoT device that has already occurred.

This determination may be performed by the operator platform after the data have been received from the at least one IoT device. By way of example, a malfunction of the IoT device may be detected if the operator platform identifies irregularities in the process flow of the IoT device. This may be the case in particular if current process parameters or current operating parameters of the IoT device deviate from target process parameters or target operating parameters. The target process parameters or target operating parameters of the IoT device in question may be obtained from a memory of the operator platform or else may be learnt by the operator platform by way of machine learning techniques, as will be explained in more detail below.

Likewise, unauthorized accessing of the IoT device may be detected if suspicious communication links between an unknown third-party device and the IoT device are identified or if manipulation of data or functional parameters that would not occur during normal operation of the IoT device is identified. The data or functional parameters for the normal operation of the IoT device may be obtained from a memory of the operator platform or else may be learnt by the operator platform by way of machine learning techniques, as will be explained in more detail below.

According to one embodiment, the evaluation of the received data comprises determining whether the received data comprise an indication of an impending malfunction of the IoT device or impending unauthorized accessing of the IoT device.

As has already been explained above, the method may initiate preventive control measures before the IoT device malfunctions and/or the unauthorized accessing of the IoT device has actually taken place. An impending malfunction or failure of the IoT device may result in a change of operating parameters that change over time. Such changes of operating parameters may thus indicate an imminent malfunction or imminent failure of the IoT device. The operator platform may again be trained to detect such indications by way of machine learning techniques.

Likewise, unauthorized accessing of the IoT device is able to be detected prior to the actual access, and thus prior to the unauthorized acquisition of data from the IoT device. By way of example, the establishment of a communication link between the IoT device and an unknown access device belonging to a third party may already be an indication of the threat of unauthorized access. In other words, there may be indicators indicating the threat of the IoT device being accessed by the access device. The operator platform may again be trained to detect such indications or indicators by way of machine learning techniques.

According to one embodiment, the method comprises, in a further step, controlling the IoT device by disconnecting the IoT device from the operator platform.

In other words, the IoT device may be actively disconnected from the operator platform if the generated state data necessitate this, that is to say if the evaluation has revealed that there are indications of a current or impending malfunction of the IoT device, or that there are indications of current or impending unauthorized accessing of the IoT device. This makes it possible to prevent a malfunction or unauthorized access from negatively impacting the operator platform. It is thus in particular possible to prevent incorrect data, which are caused by the malfunction of the IoT device, or malware, which has reached the IoT device as a result of the unauthorized access, from being forwarded on to the operator platform.

According to one embodiment, the method comprises, in a further step, controlling the IoT device by disconnecting the IoT device from an access device via which unauthorized accessing of the IoT device has taken place or is impending.

This may mean that the IoT device is controlled actively such that unauthorized accessing of the IoT device by an access device belonging to an unauthorized third party is prevented or interrupted.

According to one embodiment, the method comprises, in a further step, controlling the IoT device by disconnecting the IoT device from a network.

The IoT device may in particular be part of a network containing multiple IoT devices and/or other operator platforms. If a malfunction of the IoT device or unauthorized accessing of the IoT device is detected, a communication link between the IoT device and other IoT devices and/or other operator platforms may be disconnected in order thus to prevent the malfunction or the unauthorized access negatively impacting the other IoT devices and/or the other operator platforms.

According to one embodiment, the method comprises, in a further step, controlling the IoT device by updating software able to be executed by the IoT device.

Therefore, if a faulty or hacked IoT device is detected by the operator platform, the faulty IoT device or the hacked IoT device may receive a software update for correction.

According to one embodiment, the method comprises, in a further step, controlling the IoT device by modifying encryption data associated with the IoT device.

In other words, the faulty IoT device or the hacked IoT device may receive a key change for correction. The authorization data or access information for accessing the IoT device may be updated.

According to one embodiment, the method comprises, in a further step, a processor of the operator platform executing at least one machine learning algorithm, wherein the at least one machine learning algorithm is executed at least based on the data received from the IoT device.

The operator platform may thus have a processor that carries out the evaluation step, explained above, of the method based on a machine learning algorithm. As explained, when evaluating the collected data, a prediction may also preferably be made regarding a possible attack on or unauthorized accessing of the IoT device. This prediction may be implemented by one or more machine learning algorithms, which are able to analyze and predict the behavior of the IoT device, in particular with regard to whether a failure, fault or attack is present. In the control step, the IoT device may then be disconnected from the system as quickly as possible or even on a precautionary basis before any damage occurs.

According to one embodiment, the at least one machine learning algorithm is furthermore executed based on data that are received from at least one further IoT device. In addition or as an alternative, the at least one machine learning algorithm is furthermore executed based on data that are received from at least one further operator platform.

In other words, provision may be made to use the machine learning algorithm to learn certain functionalities on the operator platform, such that the evaluation of the received data carried out by the operator platform is based on a trained program, wherein the necessary data for the learning process may be obtained from other IoT devices and/or other operator platforms.

According to one embodiment, the method comprises, in a further step, the operator platform providing a multi-layer structure for implementing various functions of the operator platform using machine learning algorithms.

The operator platform thus preferably has a multi-layer structure (or layered structure) in order to implement various functions, for example management, monitoring, etc. using machine learning algorithms. The multi-layer structure may be structured such that a respective particular function of the operator platform is assigned to an individual layer of the multi-layer structure.

Provision may be made for some or all of the layers of the multi-layer structure to each be assigned to a machine learning algorithm that is configured to execute the function associated with the individual layer. The composition of the multi-layer structure is explained in more detail below.

According to one embodiment, the method comprises, in a further step, the operator platform providing a first layer of the multi-layer structure, wherein the first layer implements collection of the received data in a memory of the operator platform.

In other words, the data received from the IoT device may be collected in a memory of the operator platform. This data collection of data from the at least one IoT device may be associated with the first layer of the multi-layer structure. The step of collecting the received data may follow the step of receiving the data from the IoT device, and thus represent an intermediate step between receiving and evaluating the data.

According to one embodiment, the method comprises, in a further step, the operator platform providing a second layer of the multi-layer structure, wherein the second layer implements the evaluation of the received data by the operator platform and wherein the evaluation of the received data is implemented by at least one machine learning algorithm.

In other words, the data collected by the operator platform may be used as a basis for the evaluation, wherein the evaluation of the collected data, as explained above, may be trained by way of a machine learning algorithm. This also comprises monitoring the IoT device based on the collected data, for example in order to predict an attack on or unauthorized accessing of the IoT device. The evaluation of the collected data may be associated with the second layer of the multi-layer structure.

According to one embodiment, the method comprises, in a further step, the operator platform providing a third layer of the multi-layer structure, wherein the third layer implements connection or disconnection of the IoT device from the operator platform.

In other words, the result of the evaluation or monitoring by the operator platform may be used to carry out active control of the IoT device in such a way that a connection between the operator platform and the IoT device is able to be controlled or managed. In particular, the IoT device, based on the evaluation, may be actively connected to the operator platform or actively disconnected from the operator platform (what is known as connection management). The IoT device may thus be connected and, if necessary, disconnected if a fault has been detected in the IoT device or unauthorized accessing of the IoT device has been detected. These types of active controlling of the IoT device may be associated with the third layer of the multi-layer structure. The active controlling of the IoT device may in this case also be trained by way of a machine learning algorithm.

According to one embodiment, the method comprises, in a further step, the operator platform providing a fourth layer of the multi-layer structure, wherein the fourth layer implements management of the IoT device by the operator platform and wherein the management of the IoT device is implemented by at least one machine learning algorithm.

In other words, the result of the evaluation or monitoring may be used as a basis for management of the IoT device, wherein the management of the IoT device may again be trained by way of a machine learning algorithm. By way of example, in the context of the management of the IoT device, a user of the IoT device may be informed about an attack on or unauthorized accessing of the IoT device and/or about a malfunction of the IoT device. Corresponding information may be output to the user via a user interface communicatively connected to the operator platform. The management of the IoT device may be associated with the fourth layer of the multi-layer structure.

According to one aspect, what is specified is a system for operating an Internet of Things (IoT) device. The system has at least one Internet of Things (IoT) device and at least one operator platform. The operator platform is designed to receive data from the IoT device and to evaluate the received data, wherein the evaluation of the received data comprises determining whether the received data contain an indication of a malfunction of the IoT device or unauthorized accessing of the IoT device. The operator platform is furthermore designed to generate state data of the IoT device based on the evaluation, wherein the state data are representative of a current or impending state of the IoT device. The operator platform is furthermore designed to control the IoT device based on the generated state data of the IoT device.

### BRIEF DESCRIPTION OF THE FIGURES

FIG. 1 shows a system for operating an Internet of Things (IoT) device.

FIG. 2 shows a method for operating an Internet of Things (IoT) device.

FIG. 3 shows a multi-layer structure of an operator platform of a system for operating an Internet of Things (IoT) device.

### DETAILED DESCRIPTION OF EXEMPLARY EMBODIMENTS

The illustrations in the figures are schematic and not to scale. Where the same reference signs are used across different figures in the following description of the figures, these designate identical or similar elements. Identical or similar elements may also be designated by different reference signs, however.

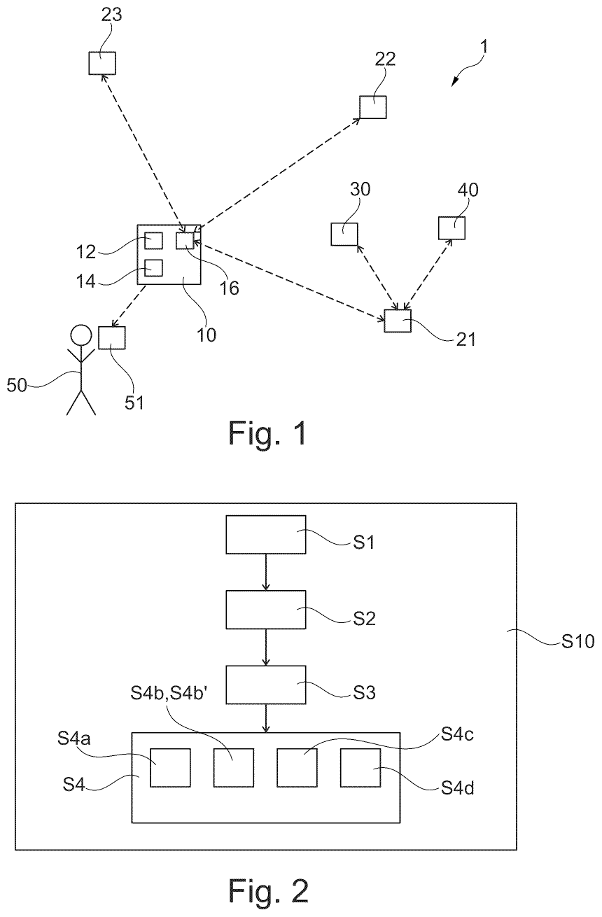

FIG. 1 shows a system 1 for operating an Internet of Things (IoT) device. The system 1 comprises at least one IoT device 21 and an operator platform 10, wherein the operator platform 10 is designed to receive data from the IoT device 21 over a wireless or wired communication link (illustrated by a dashed line in FIG. 1). The operator platform 10 may have a communication unit 16, via which wireless or wired communication with the at least one IoT device 21 takes place. The operator platform 10 may furthermore have a memory 14 in which the data received from the IoT device 21 are stored and/or collected. The operator platform 10 may furthermore have a processor 12 using which the data received from the IoT device 21 are evaluated, wherein the evaluation of the received data comprises determining whether the received data contain an indication of a malfunction of the IoT device 21 or unauthorized accessing of the IoT device 21. The processor 12 may be designed to generate state data of the IoT device 21 based on the evaluation, wherein the state data are representative of a current or impending state of the IoT device 21. The processor 12 may furthermore be designed to control the IoT device 21 based on the generated state data of the IoT device 21. By way of example, controlling the IoT device 21 may comprise disconnecting the IoT device 21 from the operator platform 10 or connecting the IoT device 21 to the operator platform 10, which may in particular comprise disconnecting or connecting the above-described wireless or wired communication link between the IoT device 21 and the operator platform 10.

The system 1 may have a multiplicity of further IoT devices. In the example shown in FIG. 1, the system 1 also comprises, in addition to the at least one IoT device 21, two further IoT devices 22, 23, which are again connected to the operator platform 10, in particular to the communication unit 16 of the operator platform 10, via a respective wireless or wired communication link (illustrated by dashed lines in FIG. 1). The data received by the operator platform 10 may thus comprise data from all IoT devices 21, 22, 23. The evaluation described herein and the control described herein may thus take place based on the received data from the multiplicity of IoT devices 21, 22, 23.

The processor 12 of the operator platform 10 may be configured to execute at least one machine learning algorithm, wherein the at least one machine learning algorithm is executed at least based on the data received from the IoT device 21. In one example, the at least one machine learning algorithm may be executed based on the data received from the multiplicity of IoT devices 21, 22, 23. In this case, the data, which represent functional parameters or operating parameters of the multiplicity of IoT devices 21, 22, 23, may be sent to the operator platform 10, as a result of which it is possible to train a program executed on the processor 12, by way of the machine learning algorithm, in such a way that the evaluation of the received data is constantly able to be developed further and is subject to a continuous learning process. In other words, the processor 12 is trained with information from the multiplicity of IoT devices 21, 22, 23, such that the detection of an indication of a malfunction of the IoT device 21 or unauthorized accessing of the IoT device 21 is able to be constantly improved.

Likewise, when the processor 12 evaluates the collected data, a prediction may also preferably be made regarding a possible impending attack on or unauthorized accessing of the IoT device 21. This prediction may also be implemented by machine learning algorithms, which are able to analyze and predict the behavior of the IoT device 21 with regard to whether a failure, fault or attack is present. The analysis or evaluation may be improved by the machine learning algorithm over time, for example using data from only the IoT device 21 or using data from the multiplicity of IoT devices 21, 22, 23. This in turn leads to an improved ability to predict an attack on or unauthorized accessing of the IoT device 21. By controlling the IoT device 21 appropriately based on the analyzed or evaluated data, the IoT device 21 is then able to be disconnected from the system 1 as quickly as possible or even on a precautionary basis before any damage occurs. Disconnection from the system 1 may mean that the IoT device 21 is disconnected only from the operator platform 10 or else that communication and data transmission between the IoT device 21 and the other IoT devices 22, 23 is prevented.

The IoT device 21 may also be part of a network 40 of further devices or appliances, wherein the IoT device 21 communicates with the network 40 over a wireless or wired communication link (illustrated by a dashed line in FIG. 1). In this case, the IoT device 21 may be controlled by actively connecting or actively disconnecting the IoT device 21 from the network 40.

Unauthorized accessing of the IoT device 21, for example what is referred to as a hacker attack thereon, may be carried out by way of an access device 30, which connects to the IoT device 21 over a wireless or wired communication link (illustrated by a dashed line in FIG. 1).

Such access may be used to install malware on the IoT device 21 or to acquire sensitive data from the IoT device 21. The method described below with reference to FIG. 2 allows the operator platform to detect such unauthorized access. It is possible to detect access that has already occurred, but also an impending attack, wherein in each case specific indications may arise in the data of the IoT device 21, these then being transmitted to the operator platform 10 for evaluation. Following evaluation of the data from the IoT device 21 and if the evaluation has revealed that accessing thereof by the access device 30 has taken place or is impending, the operator platform 10 is able to control the IoT device 21 by disconnecting the IoT device 21 from the access device 30 or interrupting the communication between the IoT device 21 and the access device 30.

This has the overall technical advantage that attacks on the IoT device 21 are not only able to be detected at an early stage by the operator or security platform 10, but these attacks are also able to prevented at an early stage, for example by disconnecting the communication link, before they are able to cause any damage. The operator platform 10 may inform a user 50, for example via a user interface 51, that the IoT device 21 has a malfunction or unauthorized accessing of the IoT device 21 is present.

FIG. 2 shows a method for operating an Internet of Things (IoT) device, for example a method for operating the IoT device 21 described with reference to FIG. 1. The method comprises, in a step S1, the operator platform 10 receiving data from the IoT device 21. In a further step S2, the method comprises the operator platform 10 evaluating the received data, wherein the evaluation of the received data comprises at least determining whether the received data comprise an indication of a malfunction of the IoT device 21 or unauthorized accessing of the IoT device 21. The method comprises, in a further step S3, generating state data of the IoT device 21 based on the evaluation, wherein the state data are representative of a current or impending state of the IoT device 21. The method comprises, in a step S4, controlling the IoT device 21 based on the generated state data of the IoT device 21. Method steps S1 to S4 may be carried out in the specified order.

In a further step S4a, the controlling described in step S4 may comprise controlling the IoT device 21 by disconnecting the IoT device 21 from the operator platform 10.

In a further step S4b, the controlling described in step S4 may comprise controlling the IoT device 21 by disconnecting the IoT device 21 from the access device 30 via which unauthorized accessing of the IoT device 21 has taken place or is impending.

In a further step S4b′, the controlling described in step S4 may comprise controlling the IoT device 21 by disconnecting the IoT device 21 from the network 40.

In a further step S4c, the controlling described in step S4 may comprise controlling the IoT device 21 by updating software able to be executed by the IoT device 21.

In a further step S4d, the controlling described in step S4 may comprise controlling the IoT device 21 by modifying encryption data associated with the IoT device 21.

Provision may furthermore be made, in a step S10, for individual or multiple functions of the operator platform 10, for example the evaluation of the data received from the IoT device 21 in step S2, to be executed by the processor 12 of the operator platform 10 by way of a machine learning algorithm.

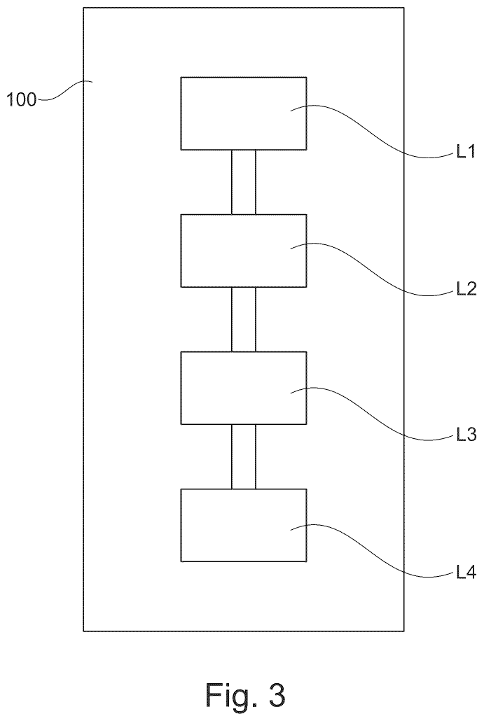

FIG. 3 shows a multi-layer structure 100 of an operator platform of a system for operating an Internet of Things (IoT) device. By way of example, FIG. 3 shows a multi-layer structure 100 of the operator platform 10 of the system 1 that was described with reference to FIG. 1. In this example, the multi-layer structure 100 of the operator platform 10 has four different layers, each of which is associated with one or more specific functions provided by the operator platform 10. Within the framework of the multi-layer structure 100, the various functions of the operator platform 10 may be implemented using machine learning algorithms. The composition of the multi-layer structure 100 is explained below.

The multi-layer structure 100 has a first layer L1 that implements collection of the received data in the memory 14 of the operator platform 10. By way of example, the first layer L1 corresponds to data collection of data from the at least one IoT device 21.

Furthermore, the multi-layer structure 100 has a second layer L2 that implements evaluation of the received data by the operator platform 10. By way of example, the second layer L2 corresponds to monitoring of the at least one IoT device 21 based on the previously collected data, for example in order to predict an attack on the IoT device 21, as described above.

Furthermore, the multi-layer structure 100 has a third layer L3 that implements or controls connection or disconnection of the IoT device 21 from the operator platform 10. By way of example, the third layer L3 corresponds to active connection of the IoT device 21 and/or active disconnection of the IoT device 21 when a fault has been detected in the IoT device 21, as described above.

Furthermore, the multi-layer structure 100 has a fourth layer LA that implements management of the IoT device 21 by the operator platform 10. The fourth layer L4 thus corresponds to management of the at least one IoT device 21, such that for example, in the event of an attack on the IoT device 21, as described above, the user 50 of the at least one IoT device 21 is able to be informed or warned.

1-15. (canceled)

16. A method for operating an Internet of Things (IoT) device, comprising:
an operator platform receiving data from at least one IoT device;
the operator platform evaluating the received data, wherein the evaluation of the received data comprises at least determining whether the received data comprise an indication of a malfunction of the IoT device or unauthorized accessing of the IoT device;
generating state data of the IoT device based on the evaluation, wherein the state data are representative of a current or impending state of the IoT device;
controlling the IoT device based on the generated state data of the IoT device.

17. The method according to claim 16, wherein the evaluation of the received data comprises determining whether the received data comprises an indication of a malfunction of the IoT device that has already occurred or unauthorized accessing of the IoT device that has already occurred.

18. The method according to claim 16, wherein the evaluation of the received data comprises determining whether the received data comprises an indication of an impending malfunction of the IoT device or impending unauthorized accessing of the IoT device.

19. The method according to claim 16, comprising:
controlling the IoT device by disconnecting the IoT device from the operator platform.

20. The method according to claim 16, comprising:
controlling the IoT device by disconnecting the IoT device from an access device via which unauthorized accessing of the IoT device has taken place or is impending; and/or controlling the IoT device by disconnecting the IoT device from a network.

21. The method according to claim 16, comprising:
controlling the IoT device by updating software able to be executed by the IoT device.

22. The method according to claim 16, comprising:
controlling the IoT device by modifying encryption data associated with the IoT device.

23. The method according to claim 16, comprising:
a processor of the operator platform executing at least one machine learning algorithm,
wherein the at least one machine learning algorithm is executed at least based on the data received from the IoT device.

24. The method according to claim 23, wherein the at least one machine learning algorithm is furthermore executed based on data that are received from at least one further IoT device; and/or
wherein the at least one machine learning algorithm is furthermore executed based on data that are received from at least one further operator platform.

25. The method according to claim 16, comprising:
the operator platform providing a multi-layer structure for implementing various functions of the operator platform using machine learning algorithms.

26. The method according to claim 25, comprising:
the operator platform providing a first layer of the multi-layer structure, wherein the first layer implements collection of the received data in a memory of the operator platform.

27. The method according to claim 25, comprising:
the operator platform providing a second layer of the multi-layer structure,
wherein the second layer implements the evaluation of the received data by the operator platform;
wherein the evaluation of the received data is implemented by at least one machine learning algorithm.

28. The method according to claim 25, comprising:
the operator platform providing a third layer of the multi-layer structure,
wherein the third layer implements connection or disconnection of the IoT device from the operator platform.

29. The method according to claim 25, comprising:
the operator platform providing a fourth layer of the multi-layer structure,
wherein the fourth layer implements management of the IoT device by the operator platform;
wherein the management of the IoT device is implemented by at least one machine learning algorithm.

30. A system for operating an Internet of Things (IoT) device, comprising:
at least one Internet of Things (IoT) device;
at least one operator platform;
wherein the operator platform is designed to receive data from the IoT device;
wherein the operator platform is designed to evaluate the received data, wherein the evaluation of the received data comprises determining whether the received data comprises an indication of a malfunction of the IoT device unauthorized accessing of the IoT device;
wherein the operator platform is designed to generate state data of the IoT device based on the evaluation, wherein the state data are representative of a current or impending state of the IoT device;
wherein the operator platform is designed to control the IoT device based on the generated state data of the IoT device.
